(19) United States
(12) Patent Application Publication
(10) Pub. No.: US 2008/0233455 A1
(43) Pub. Date: Sep. 25, 2008

(54) Proton conductors based on aromatic polyethers and their use as electolytes in high temperature pem fuel cells

(76) Inventors: Valadoula Deimede, Patras (GR); Nora Gourdoupi, Patras (GR)

Correspondence Address: Edwards Angell Palmer & Dodge LLP, P.O. Box 55874, Boston, MA, 02205, US

(21) Appl. No.: 12/077,821

(22) Filed: Mar. 21, 2008

Related U.S. Application Data
(60) Provisional application No. 60/919,490, filed on Mar. 21, 2007.

(51) Int. Cl. H01M 8/10

(52) U.S. Cl. 429/33

(57) ABSTRACT

Polymer electrolyte membranes with polyethylene oxide and phophonic acid moieties tethered on the main polyether backbone are provided as single phase proton conductors. Preferred polymers can exhibit good mechanical properties, high thermal and oxidative stability. The membrane-electrode assembly (MEA) is also provided.

The present application claims the benefit of U.S. provisional application No. 60/919,490 filed on Mar. 21, 2007, incorporated herein by reference in its entirety.

### FIELD OF THE INVENTION

The present invention provides new polymer materials and methods of synthesis. In particular, the present invention provides high temperature polymer electrolytes which are provided with good intrinsic proton conduction without the need of a second phase, and good mechanical integrity at temperatures ranging between 100-140° C. The intrinsic proton conduction is provided by incorporating acidic and/or basic groups into a main polymer. These materials can be used to form proton conducting membranes useful, for example, as high temperature polymer electrolyte membrane fuel cells operating within the range of the aforementioned temperatures.

### BACKGROUND

Polymer electrolyte membrane fuel cells (PEMFCs) operating at 90° C. are currently the best candidates for use in stationary and automobile applications. Up to now, perfluorinated sulfonic acid polymers (PFSA) exemplified by polymers from Dupont (Nafion®), Asahi Chemicals (Aciplex®) and others, have been applied almost exclusively as low temperature polymer electrolytes. These membranes possess very desirable properties including good mechanical strength, chemical stability, and high conductivity (Solid State Ionics 2001, 145, 3) which has allowed them to revolutionize fuel cell technology, and enabled very high energy densities. However, these membranes remain expensive and have several limiting factors such as low conductivity at low relative humidity (RH) (J. Power Sources 2002, 109, 356, J. Memb. Sci. 2001, 185, 29), high methanol permeability (J. Electrochem. Soc. 1997, 97, 1) and a low glass transition temperature (Tg) (J. Electrochem. Soc. 2002, 149, A 256, J. New Mater. Electrochim. System 1998, 1, 47) which restricts their application to below 100° C.

All existing membrane materials for PEM fuel cells operating below 100° C. rely on absorbed water and its interaction with acid groups which act as proton exchange sites to facilitate ionic conductivity. An alternative approach for the development of proton conducting materials for low temperature PEM fuel cells is the incorporation of hydrophilic poly (ethylene oxide) units onto a stiff polymer backbone. Poly (ethylene oxide) (PEO)-based polymeric electrolytes are still among the most extensively studied polymeric conductors since their structures are beneficial for supporting fast ion transport (Adv. Mater. 1998, 10, 439.) A main drawback is the high crystallinity which limits the high ionic conductivity of PEO-based electrolytes (Solid State Ionics 1983, 11, 91, Macromolecules 1994, 27, 7469, Nature 2001, 414, 359). Efforts to enhance the ionic conductivity of PEO-based electrolytes have focused on suppressing its crystallinity by the use of polymer architectures where short PEO chains are attached as pendant chains to backbone polymers (J. Am. Chem. Soc. 1984, 106, 6854, Chem. Mater. 2003, 15, 2005, Macromolecules 2000, 33, 8604), incorporated in block copolymers (J. Electrochem. Soc. 1999, 146, 32) or blended with other polymers (Macromolecules 2004, 37, 8424) in which PEO forms the conductive phase and the other component acts as a mechanical support. Further, aromatic poly (arylene ether) copolymers grafted with poly (ethylene oxide) (PEO) have been synthesized and showed very good mechanical and film-forming properties, high thermal stability and high water uptake (Macromolecules 2005, 38, 9594).

Operation at temperatures above 100° C. affords several attractive advantages including higher CO tolerance (Chem. Mater. 2003, 15, 4896, Solid State Ionics 1997, 97, 1), better kinetics of reactions such as the oxygen reduction reaction (ORR), and improved water and thermal management. For the increase of operation temperature there are two general approaches. The one includes the use of additives to prevent the loss of water from ionic regions (pores) in the membrane, thereby maintaining conductivity similar to that which is typically observed below the boiling point. In this context, several hydrophilic inorganic gel materials such as SiO₂, TiO₂, Zr(HPO₄)₂, and heteropolyacids, have been incorporated in conventional perfluorinated membranes such as Nafion® (Solid State Ionics 1999, 125, 431, J. Electrochem. Soc. 1996, 143, 3847, Solid State Ionics 2001, 145, 101, J. Power Sources 2001, 103,1, J. Membr. Sci. 2000, 172, 233). However in these systems, maintaining proton conductivity within the bulk of the polymer membrane depends on a delicate water balance including the interfacial reaction zone restricts its application in simpler systems and to a temperature of up to 140° C., thereby excluding it from achieving the true advantages of elevated temperature operation (better kinetics and thermal management). The second approach includes the replacement for water by non-volatile solvents such as phosphoric acid, imidazole, butyl methyl imidazolium triflate, and butyl methyl imidazolium tetrafluoroborate (Electrochim. Acta 1996, 41, 193, J. Electrochem. Soc. 2000. 147, 34, Solid State Ionics 1999, 125, 225).

In the non-aqueous membrane field the current state of the art is the H₃PO₄ based PBI membrane (J. Electrochem. Soc. 2004, 151, A8). Being sulfonated (U.S. Pat. No. 4,814,399), phosphonated (U.S. Pat. No. 5,599,639) or doped with a strong acid (U.S. Pat. No. 5,525,436 and J. Electrochem. Soc. 1995, 142, L21), PBI becomes a proton conductor at temperatures up to 200° C. This polymer membrane can be used as electrolyte for PEM fuel cells with various types of fuels such as hydrogen (Electrochim. Acta, 1996, 41, 193), methanol (J. Appl. Electrochem. 1996, 26, 751), trimethoxymethane (Electrochim. Acta, 1998, 43, 3821) and formic acid (J. Electrochem. Soc. 1996, 143, L158). PBI exhibits high electrical conductivity (J. Electrochem. Soc. 1995, 142, L21), low methanol crossover rate (J. Electrochem. Soc. 1996,143, 1225), nearly zero water drug coefficient (J. Electrochem. Soc. 1996, 143, 1260), and enhanced activity for oxygen reduction (J. Electrchem. Soc. 1997, 144, 2973). The PBI/H₃PO₄ major drawback, regarding their application in fuel cell technology is their low oxidative stability against the free radicals that are formed during fuel cell operation both at the cathode and anode electrodes. From the cathode electrode stand point operation has to be scaled above the onset potential of hydrogen peroxides thereby forcing the cell operation at higher cell voltages and subsequently to lower current and power densities. Another approach that has received much attention are the ionically cross-linked acid-base blends, that posses high conductivity, thermal stability and mechanical flexibility and strength. Combination of the acidic polymers (sulfonated polysulfone, sulfonated polyethersulfone or sulfonated polyetheretherketone) and the basic polymers (polybenzimidazole (PBI), polyethyleneimine and poly(4-vinylpyridine)) have been explored (Solid State Ionics 1999, 125, 243, J. New Mater. Electrochem. Syst. 2000, 3, 229). Further sulfonated polysulfone/PBI membranes doped with phosphoric acid have been investigated and exhibit excellent chemical and thermal stability and good proton conductivity (Macromolecules 2000, 33, 7609, Electrochim. Acta 2001, 46, 2401, J. Electrochem. Soc. 2001, 148, A513). Additionally, blends of PBI with aromatic polyether copolymer containing pyridine units in the main chain have also been prepared, resulting in easily doped membranes with excellent mechanical properties and superior oxidative stability (J. Membr. Sci. 2003, 252, 115). This invention describes the development of alternative low cost polymeric systems that will combine all the desired properties for application in fuel cells operating at temperatures above 120° C.

New membranes based on aromatic polyether containing pyridine units have shown very promising properties especially due to their significantly higher oxidative stability and their excellent mechanical properties (Chem. Mater. 2003, 15, 5044, J. Membr. Sci. 2005, 252, 115). The latter have shown comparable or higher fuel cell performance as compared to PBI state of the art membranes at temperatures of 140-160° C. (US20060909151049). Despite their promising properties in terms of ionic conductivity, mechanical properties and oxidative stability, their potential application in fuel cell technology can be limited due to the H₃PO₄ leaching from the membrane and the increased amount of Pt catalyst loading needed on the electrodes.

Self-sustained proton conductors have been reported as the most promising technological approach against the leaching of phosphoric acid and the highly corrosive environment of the acid doped membrane electrode assemblies. Recently, research has been reported including mixtures of acidic surfactants (i.e. monododecylphosphate, MDP) and organic base benzimidazole (BnIm) (Electrochim. Acta, 2003, 48, 2411), MDP and the basic surfactant 2-undecylimidazole (UI) (J. Phys. Chem. B, 2004, 108, 5522), phosphorylated chitin (CP) and imidazole (Imi) (Angew. Chem. Int. Ed. 2004, 43, 3688), MDP and the RNA base uracil (Chem.Phys.Chem. 2004, 5, 724), phosphorylated chitin (CP) and uracil (U) (J. Am. Chem. Soc. 2005,127, 13092).

One conventional method for forming MEA's is direct membrane catalyzation. Direct catalyzation of the membrane has been described in various patents and scientific literature primarily on aqueous based polymer electrolytes, most notably of the perfluorinated sulfonic acid type. Such methods are not reasonably translated to mass manufacturability keeping reproducibility (batch vs. continuous) and cost in perspective. Depending on the deposition methods used, the approach towards lowering noble metal loading can be classified into four broad categories, (i) thin film formation with carbon supported electrocatalysts, (ii) pulse electrodeposition of noble metals (Pt and Pt alloys), (iii) sputter deposition (iv) pulse laser deposition and (v) ion-beam deposition. While the principal aim in all these efforts is to improve, the charge transfer efficiency at the interface, they can further result in modification of the electrocatalyst.

In the first of the four broad categories using the ‘thin film’ approach in conjunction with conventional carbon supported electrocatalysts, several variations have been reported, these include (a) the so called ‘decal’ approach where the electrocatalyst layer is cast on a PTFE blank and then decaled on to the membrane (J. App. Electrochem. 1992, 22, 1, J. Power Sources 1998, 71, 174). Alternatively an ‘ink’ comprising of Nafion® solution, water, glycerol and electrocatalyst is coated directly on to the membrane (in the Na⁺ form) (J. Electrochem. Soc. 1992, 139(2), L28). These catalyst coated membranes are subsequently dried (under vacuum, 160° C.) and ion exchanged to the H⁺ form (J. App. Electrochem. 1992, 22, 1). Modifications to this approach have been reported with variations to choice of solvents and heat treatment (J. Power Sources 2003,113(1), 37, Electrochim. Acta 2005, 50(16-17), 3200) as well as choice of carbon supports with different microstructure (J. Electrochem. Soc. 1998, 145(11), 3708). Other variations to the ‘thin film’ approach have also been reported such as those using variations in ionomer blends (WO Pat., (E.I. Dupont de Nemours and Company, USA). 2005, 24 pp.), ink formulations (GS News Technical Report 2004, 63(1), 23), spraying techniques (Proc.-Electrochem. Soc. 94-23 (Electrode Materials and Processes for Energy Conversion and Storage), 1994, 179; IN Pat., (India). 1998, 13 pp), pore forming agents (Dianhuaxue 2000, 6(3), 317), and various ion exchange processes (GS News Technical Report 2003, 62(1), 21). At its core, this approach relies on extending the reaction zone further into the electrode structure away from the membrane, thereby providing for a more three dimensional zone for charge transfer. Most of the variations reported above thereby enable improved transport of ions, electrons and dissolved reactant and products in this ‘reaction layer’ motivated by need to improve electrocatalyst utilization. These attempts in conjunction with use of Pt alloy electrocatalysts have formed the bulk of the current state of the art in the PEM fuel cell technology. Among the limitations of this approach are problems with controlling the Pt particle size (with loading on carbon in excess of 40%), uniformity of deposition in large scale production and cost (due to several complex processes and/or steps involved).

An alternative method for enabling higher electrocatalyst utilization has been attempted with pulse electrodeposition. (J. Electrochem. Soc. 1992, 139(5), L45) one of the first to report this approach used pulse electrodeposition with Pt salt solutions which relied on their diffusion through thin Nafion® films on carbon support enabling electrodeposition in regions of ionic and electronic contact on the electrode surface. See a recent review on this method (WO Pat., (Faraday Technology, Inc., USA). 2000, 41 pp) describing various approaches to pulse electrodeposition of catalytic metals. In principal this methodology is similar to the ‘thin film’ approach described above, albeit with a more efficient electrocatalyst utilization, since the deposition of electrocatalysts theoretically happens at the most efficient contact zones for ionic and electronic pathways. Improvements to this approach have been reported (Electrochem. and Solid-State Lett. 2001, 4(5), A55), (Plating and Surface Finishing 2004, 91(10), 40). Such methods have associated concerns with the ability to scale upwards for mass manufacturing.

Sputter deposition of metals on carbon gas diffusion media is another alternative approach. Here, however, the interfacial reaction zone is more in the front surface of the electrode at the interface with the membrane. The original approach in this case was to put a layer of sputter deposit on top of a regular Pt/C containing conventional gas diffusion electrode. Such an approach (Electrochim. Acta 1993, 38(12), 1661) exhibited a boost in performance by moving part of the interfacial reaction zone in the immediate vicinity of the membrane. Recently promising results have been reported (Electrochim. Acta 1997, 42(10), 1587) with thin layer of sputter deposited Pt on wet proofed non catalyzed gas diffusion electrode (equivalent to 0.01 mg_{Pt}/cm²) with similar results as compared to a conventional Pt/C (0.4 mg_{Pt}/cm²) electrode obtained commercially. Later (J. Electrochem. Soc. 1999, 146, 4055), have used an approach with multiple sputtered layers (5 nm layers) of Pt interspersed with Nafion®-carbon-isopropanol ink, (total loading equivalent of 0.043 mg_{Pt}/cm²) exhibiting equivalent performance to conventional commercial electrodes with 0.4 mg_{Pt}/cm². The effect of the substrate on the sputtered electrodes was studied (J. Electrochem. Soc. 149, 2002, A862). Further, on a study of the sputter layer thickness has reported best results with a 10 nm thick layer. Further advancements have been made with sputter deposition as applied to direct methanol fuel cells (DMFC) (Electrochem. and Solid-State Lett. 2000, 3(11), 497; Proc.-Electrochem. Soc. 2001-4(Direct Methanol Fuel Cells): 2001, 114), wherein several fold enhancements in DMFC performance was reported compared to electrodes containing unsupported PtRu catalyst. Catalyst utilization of 2300 mW/mg at a current density of 260 to 380 mA/cm² was reported (Electrochem. and Solid-State Lett. 2000, 3(11), 497; Proc.-Electrochem. Soc. 2001-4(Direct Methanol Fuel Cells): 2001, 114). While the sputtering technique provides for a cheap direct deposition method, the principal drawback is the durability. These techniques generally provide relatively poor adherence to the substrate and under variable conditions of load and temperature. Further, there is a greater probability of dissolution and sintering of the deposits.

An alternative method dealing direct deposition was recently reported using pulsed laser deposition (Electrochem. and Solid-State Lett. 2003, 6(7), A125). However this method has only been suitably applied with the anode electrodes, not the cathode.

### SUMMARY

The present invention relates to polymeric materials that are self-sustained proton conductors. These materials are provided with good intrinsic proton conduction without the need of a second phase (e.g. acid or water impregnation). For example, the materials can be provided with intrinsic proton conduction ranging from about 0.05-0.1 S/cm. The materials are further provided with good mechanical integrity at temperatures in excess of 100° C., for example, ranging between about 100-140° C. In particular, the materials possess chemical and thermal stability at such temperatures.

The materials comprise a main polymer or copolymer chain having incorporated acidic and/or basic groups. In particular embodiments, the materials comprise polymer or copolymer chains having one or more acidic and/or basic groups tethered or attached to the polymer or copolymer backbone.

In one aspect, the invention generally relates to polymer electrolytes with intrinsic proton conduction comprising one or more polyethylene oxide (PEO) moieties and at least one phosphonic acid moieties incorporated onto the polymer backbone. In some embodiments, the polymer backbone is a polyether backbone. The one or more PEO moieties can be provided with the same or different molecular weights. In some embodiments, one to four phosphonic acid moieties are provided.

In another aspect, the invention generally relates to a method for producing polymeric materials that are self-sustained proton conductors. According to the methods, the polymeric materials are provided with good intrinsic proton conduction without the need of a second phase (e.g. acid or water impregnation). According to the methods, one or more acidic and/or basic groups are incorporated into a main polymer or copolymer chain. The one or more acidic and/or basic groups can be attached or tethered to the backbone of the polymer or copolymer chain.

Embodiments according to these aspects of the invention can include the following features. One or more polymers can be provided in the form of block, random, periodic and/or alternating polymers. Two or more distinct polymers can be provided. The polymer can be obtainable via a nucleophilic aromatic substitution reaction. The polymer can be synthesized by reaction of materials comprising one or more aromatic difluorides. The polymers can be used as is or mixed with organic base heterocycles such as imidazol, pyrazole, methyl-imidazole or other imidazole derivatives. The polymer can comprise a structure of formula (I), (II), and/or (III) below:

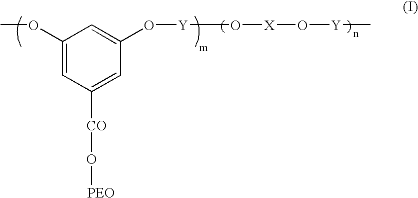

wherein Y is the same or is different and is bis-(4-fluorophenyl)sulfone, 4,4′-difluorobenzophenone, decafluorobiphenyl, and bis(4-fluorophenyl)phenylphosphine oxide. X is aromatic unit composed of one, two or three benzene or heteroaromatic rings bearing one to four phosphonic acid moieties. n is a positive integer between 0.95-0.7, and m is a positive integer between 0.05-0.3. The functionalized PEO macromonomer comprises polyethylene oxide moieties of different molecular weights ranging from 750-5000.

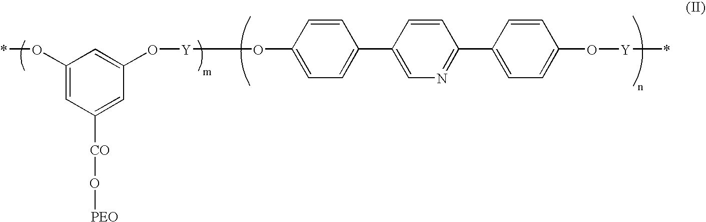

wherein Y is the same or is different and is bis-(4-fluorophenyl)sulfone, 4,4′-difluorobenzophenone, decafluorobiphenyl, or bis(4-fluorophenyl)phenylphosphine oxide. n is a positive integer between 0.95-0.7 and m is a positive integer between 0.05-0.3. The functionalized PEO macromonomer comprises polyethylene oxide moieties of different molecular weights ranging from 750-5000.

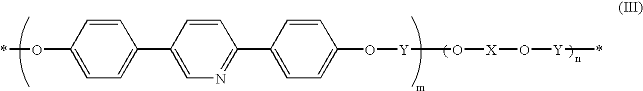

wherein Y is the same or different and is bis-(4-fluorophenyl)sulfone, 4,4′-difluorobenzophenone, decafluorobiphenyl or bis(4-fluorophenyl)phenylphosphine oxide. m is a positive integer between 0.95-0.5 and n is a positive integer between 0.05-0.5.

In another aspect, the invention generally relates to the polymers described provided in the membrane form.

In another aspect, the invention generally relates membrane electrode assemblies (MEA) comprising polymers described herein. The MEA's can comprise, in some embodiments, an anode-membrane-cathode sandwich. In some embodiments, each electrode in the sandwich structure comprises separate layers comprising (i) a substrate layer, (ii) a gas diffusion layer and (iii) a reaction layer.

Other aspects of the invention are disclosed infra.

### DETAILED DESCRIPTION

As discussed above, new polymeric materials and methods for manufacture are provided. The polymeric materials include a polymer or copolymer chain having one or more acidic and/or basic groups incorporated therein. In certain embodiments, one or more acidic and/or basic groups are tethered or attached to the polymer or copolymer backbone, for example, by chemical interaction. These polymeric materials are proton conductors, particularly self-sustained proton conductors, and can be used, for example, as polymer electrolytes in high temperature polymer electrolyte membrane fuel cells operating at high temperatures (e.g. 100° C. and higher).

Without being bound by theory, it is believed that the acidic and/or basic groups are able to interact together and are organized into ionic moieties, thereby forming a continuum proton conduction pathway.

The polymeric materials can be used as single-phase self-sustained proton conductors and, thus, do not require the use of a second phase such as an additional liquid or acid phase (e.g. impregnation of a second phase such as water or inorganic acid into the polymer matrix).

Particularly preferred polymers of the invention may include a structure of the following formulae (I), (II), (III).

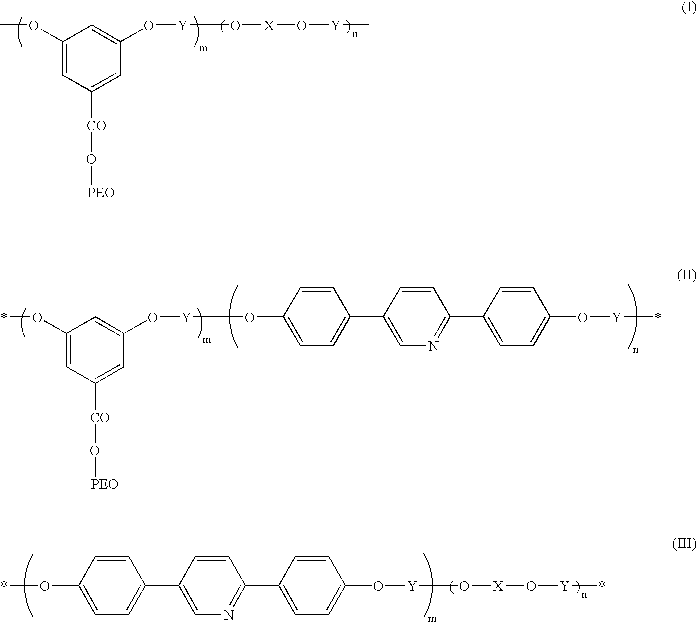

wherein Y is the same or different and is 4(fluorophenyl sulfone), decafluorobiphenyl, 4,4′-difluorobenzophenone, or bis(4-fluorophenyl)phenylphosphine oxide. X is aromatic unit composed of one, two or three benzene or heteroaromatic rings bearing one to four phosphonic acid moieties. For I and II n is a positive integer between 0.95-0.7 and m is a positive integer between 0.05-0.3. The functionalized PEO macromonomer comprises polyethylene oxide moieties of different molecular weights (e.g., from about 750 to about 5000).

In some embodiments, the polymer is a polyether polymers and/or copolymers. In certain embodiments, aromatic polyether polymers and/or copolymers are provided. Aromatic polyether backbones provide additional benefits such as enhanced oxidative and thermal stability.

In accordance with some embodiments, the polymer contains polyethylene oxide (PEO) and/or phosphonic moieties. Functionalized PEO macromonomers which comprises polyethylene oxide moieties of different molecular weights can suitably be used. The molecular weights can be determined based on the desired properties, and can range, for example, from about 750-5000.

In particular embodiments, blends of two or more distinct polymers are provided such as a first polymer having a structure of formula (I) above blended with one or more further polymers having a structure of formulae II and/or III above.

In an exemplary embodiment, polymers or polymer blends of the invention can be mixed suitably with organic base heterocycles such as imidazol, pyrazole, methyl-imidazole or other imidazole derivatives so as to provide one or more basic groups tethered to the polymer backbone.

Suitable acidic groups that are incorporated into or otherwise tethered or attached to the polymer or copolymer chain can include, for example, phosphonic groups (—H₂PO₃). In some embodiments, one or more phosphonic groups (—H₂PO₃) are used to provide the acidic moieties or groups.

Suitable basic groups that are incorporated into or otherwise tethered or attached to the polymer or copolymer chain can include, for example, PEO. In an exemplary embodiment, PEO side chains are provided as the basic groups.

In some embodiments, one or more fluorinated groups having strong hydrophobic character are included to assist in the phase separation and the clustering of the ionic groups formed by the acidic and/or basic groups.

Methods for forming the polymeric materials are also provided. These methods involve the incorporation of acidic and/or basic groups into the polymer. In some embodiments, methods include chemically attaching or tethering one or more acidic and/or basic groups to the polymer or copolymer chain, particularly to the polymer or copolymer backbone.

In one embodiment, polymers of the invention may be suitably prepared by nucleophilic aromatic substitution (See, e.g., Polymer 1984, 25, 1827, J. Polym. Sci., Part A: Polym. Chem., 2003, 41, 2264, J. Membr. Sci., 2004, 239, 119, U.S. Pat. No. 5,387,629(1993), EP1611182A2(2004), WO0225764A1(2002)). For example, the polymers can be synthesized via nucleophilic aromatic substitution of aromatic difluorides such as bis-(4-fluorophenyl)sulfone, decafluorobipheynyl, 4,4′difluorobenzophenone, bis(4-fluorophenyl)phenylphosphine oxide with aromatic diols bearing phosphonic moieties and macromoner diols bearing PEO moieties. Functionalized PEO macromonomers were synthesized according to published procedure (See, e.g., Chem. Eur. J. 2002, 8, 467).

In one exemplary embodiment, aromatic polyethers comprising phosphonated aromatic rings are synthesised. More specifically, aromatic polyethers comprising phosphonated aromatic rings having the following chemical structures are synthesized:

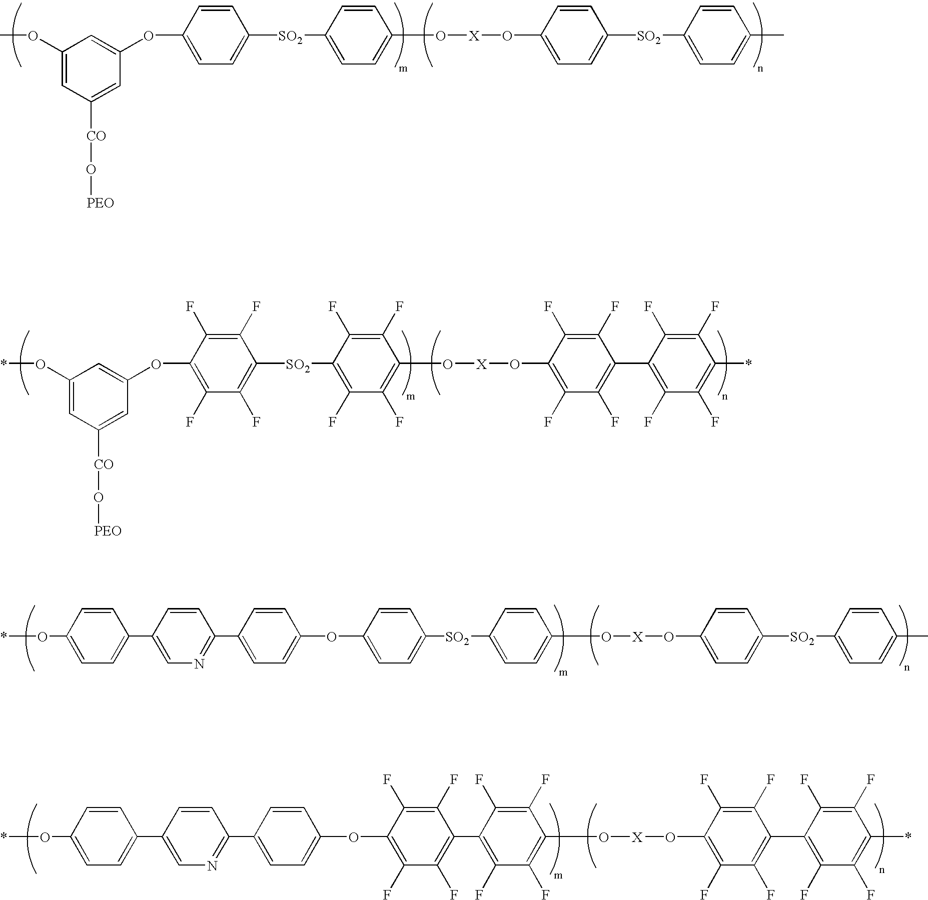

Where X is selected from:

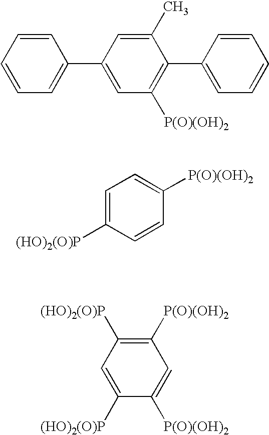

The present invention also includes preparation of membrane electrode assemblies (MEA). In particular, methods are provided for the preparation of an anode-membrane-cathode sandwich, e.g. where each electrode in the sandwich structure comprises separate layers including (i) a substrate layer, (ii) a gas diffusion layer and (iii) a reaction layer.

In certain embodiments, the present membranes are prepared by film casting of polymer solutions. In general, one or more polymers are dissolved in a suitable solvent, typically at room temperature. The proper solvents can be readily determined by one of skill in the art and can include, for example polar aprotic solvents such as N,N-dimethylacetamide. In the case of blends mixing of corresponding polymer solutions in the proper ratio is performed. The resulting solution is poured into a glass dish or the like and the solvent is evaporated (e.g. in an oven at 80-100° C. for about 24 h). The resulting membranes can be further dried under reduced pressure and vacuum, optionally in combination with elevated temperature such as at 100-130° C., to remove residual solvent. In some embodiments, polymers having melting temperatures up to 300° C. are used, and, in such cases, melt extrusion can be used for continuous membrane preparation.

In some embodiments, polymer electrolyte membranes of the invention can be mixed suitably with organic base heterocycles such as imidazol, pyrazole, methyl-imidazole or other imidazole derivatives.

The invention also includes membrane electrode assemblies comprising polymer electrolyte membranes as disclosed herein. Preferred membrane electrode assemblies include a layered sandwich structure herein referred to as membrane electrode assembly (MEA) comprising of anode-membrane-cathode sandwich. Each electrode in this sandwich structure can comprise separate layers. These layers can include a (i) substrate layer, (ii) a gas diffusion layer and (iii) a reaction layer. Individual components may be commercially available such as (i) the substrate layer or materials for gas diffusion layer and the catalysts in (iii) the reaction layer.

The membrane electrode assemblies (MEA) of the present invention, which use the new polymeric materials provide the improved properties discussed herein. The membrane electrode assemblies comprise (a) gas diffusion and current collecting electrode component, (b) a newly formulated reaction layer component comprising catalyst and ion conducting elements in conjunction with crosslinkers, and (c) a choice of Pt alloy electrocatalysts for enhanced CO tolerance and oxygen reduction reaction activity.

### Gas Diffusion Electrode Component.

As the electrode component, a variety of materials may be utilized. For example, an electrically conducting substrate may be suitably chosen from a combination of woven carbon cloth (such as Toray fiber T-300) or paper (such as the Toray TGP-H-120). Typical porosities of the carbon substrate is between about 75-85%. Such substrates can be wet-proofed using TFE based solutions (DuPont, USA). The wet proofing can be achieved with a combination of dip coating for fixed duration (e.g. between 30 seconds to 5 minutes) followed by drying (e.g. in flowing air). Such a wet proofed substrate can be coated with a gas diffusion layer of select carbon blacks and PTFE suspension. Suitable carbon blacks can include those ranging from Ketjen black to turbostratic carbons such as Vulcan XC-72 (Cabot Corp, USA) with typical surface areas in the range of about 250-1000 m²/gm. The gas diffusion layer can be deposited, for example, by a coating machine such as Gravure coaters from Euclid coating systems (Bay City, Mich., USA). In embodiments of the invention, a slurry comprising of a composition of carbon black and PTFE (poly tetrafluoro ethylene)aqueous suspension (such as Dupont TFE-30, Dupont USA) is applied to a set thickness (e.g. 50-500 microns) over the carbon paper or cloth substrate, for example, with the aid of the coating machine. In some embodiments, pore forming agents can be used to prepare the gas diffusion layer. Suitable pore forming agents include, for example, various combinations of carbonates and bicarbonates (such as ammonium and sodium analogs). By carefully controlling the pore formers, control of gas access to the reaction zone is provided. In particular, pore forming agents are incorporated into slurry mixtures comprising of carbon black and PTFE suspension. Typical porosities provided by use of pore forming agents differs from anode and cathode electrodes and ranges from about 10-90%. Coated carbon substrates containing the gas diffusion layers are then sintered to enable proper binding of components. Sintering can be achieved using thermal treatment to temperatures significantly above the glass transition point for PTFE, usually in the range 100 to 350° C. for 5 to 30 mins.

### Formation of Reaction Layer Comprising Electrocatalyst and Ion Conducting Components:

On the surface of the gas diffusion layer, an additional layer is provided which comprises a carbon supported catalyst, ion conducting elements (e.g. formulae I, II, III and/or blends thereof), and pore forming agents. This layer can be provided using a variety of methods such as spraying, calendaring, and/or screen printing.

Typically, an appropriate electrocatylist is first chosen based on whether anode or cathode electrodes are used. For example, for anode electrodes, Pt in conjunction of another transition metal, such as Ru, Mo, Sn can be suitably used. This is due to the formation of oxides on these non-noble transition metals at lower potentials, which enables oxidation of CO or other C₁ moieties that are typically in the output feed of fuel reformers (steam reformation of natural gas, methanol, etc.). The choice of electrocatalyst can include Pt and one or more second transition element either alloyed or in the form of mixed oxides. The selection generally takes into account the application based on choice of fuel feed-stock. The electrocatalysts are typically in the form of nanostructured metal alloys or mixed oxide dispersions on carbon blacks (e.g., turbostratic carbon support materials such as Ketjen black or similar material).

As the cathode electrocatalysts, those that are resistant or relatively immune from anion adsorption and oxide formation are particularly suitable. In this case, the choice of the alloying element can range from first row transition elements, typically Ni, Co, Cr, Mn, Fe, V, Ti, etc. It has been shown that adequate alloying of these transition elements with Pt results in deactivation of Pt for most surface processes (lowering of surface workfunction) (Electrochim. Acta 2002, 47, 3219, Fundamental Understanding of Electrode Processes, Proc.—Electrochem. Soc, Pennington, N.J. 2003; J. Phys. Chem. B 2004, 108(30), 11011, J. Electrochem. Soc. 2005, 152, A2159). This renders the surface largely bare for molecular oxygen adsorption and subsequent reduction. In addition to choice of alloys, the use of perflurosulfonic acids (either alone or as a blend with other ion conductors) can provide enhance oxygen solubility. It is well known that oxygen solubility is approximately eight times higher in these fluorinated analogs as compared to phosphoric acid based components (Electrochim. Acta 48, 2003, 1845). The electrocatalyst of choice is obtained from commercial vendors such as Columbian Chemicals (Marrietta, Ga., USA), Cabot Superior Micro-powders (Albuquerque, N. Mex., USA). Typical weight ratios of the catalyst on carbon support can range from about 30-60% of metal on carbon.

The next step involves preparation of a slurry using a combination of electrocatalyst in a suspension containing a solubilized form of the polymer substrate (e.g. formulae I, II, and/or III). In addition pore forming components (e.g. based on a combination of carbonates and bicarbonates) are added, typically in a ratio of about 5-10% by weight. The ratio of the components have a variation of 10-30% within a choice of each component, enabling a total catalyst loading of 0.3 to 0.4 mg of Pt or Pt alloy/cm². The slurry is then applied by suitable methods such as, for example, application of calendaring, screen printing, and/or spraying.

After the reaction layer has been formed by the catalyst application, the electrode layer is sintered and dried. A two step process can suitable be used in which the electrodes are subjected and initial drying process at suitable temperatures (e.g. about 160° C. for about 30 mins), followed by sintering at suitable temperatures (e.g. in the range of about 150-350° C. for about 30 mins to 5 hrs).

### Formation of Membrane Electrode Assembly:

The membrane electrode assemblies can be prepared by the use of a die, wherein a sandwich of the anode membrane and cathode electrodes is placed in an appropriate arrangement of gasket materials, typically a combination of polyimide and polytetrafluorethylene (PTFE, Dupont, USA). This is followed by hot pressing which can be accomplished using a hydraulic press or the like. In some embodiments, suitable pressures range from about 0.1 to about 10 bars, and can be applied with platen temperatures in the range of, e.g. about 150-250° C. for time periods typically ranging from about 10-60 mins. The membrane electrode assemblies are generally provided with thicknesses ranging from about 75-250 micrometers. This provides for a final assembly of the membrane electrode assembly.

The present methods provide more effective control of interfacial transport of dissolved reactants, protons, and electrons than conventional methods.

In this embodiment we describe a method for improving the catalyst utilization at the interface of the intrinsic polymer electrolyte. The tethering of ionic moieties onto the polymer backbone ensures the ionic conductivity within the reaction layer (catalyst containing zone at the interface between the electrode and the membrane). The absence of phosphoric acid or any other acid encounters the problem of a possible leaching. This is particularly important from the perspective of long term sustained powered density as well as better tolerance to both load and thermal cycling (especially transitions to below the condensation zone).

What is claimed is:

1. A proton conducting polymer electrolyte material comprising:
a polymer comprising a polyether backbone;
one or more polyethylene oxide (PEO) moieties, the one more PEO moieties having the same or different molecular weights and being incorporated onto the polyether backbone; and
one to four phosphonic acid moieties incorporated onto the polyether backbone.

2. The polymer electrolyte material of claim 1, wherein the polymer has the formula (I): 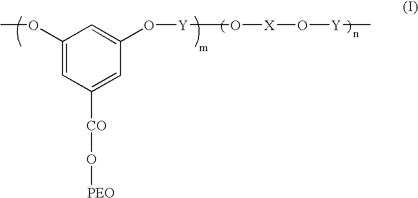
wherein Y is the same or different and is at least one of bis-(4-fluorophenyl)sulfone, 4,4′-difluorobenzophenone, decafluorobiphenyl, and bis(4-fluorophenyl)phenylphosphine oxide;
X is an aromatic unit having one, two or three benzene or heteroaromatic rings bearing one to four phosphonic acid moieties;
n is a positive integer between 0.95-0.7;
m is a positive integer between 0.05-0.3; and
PEO comprises a polyethylene oxide moiety having a molecular weight ranging from 750 to 5000.

3. The polymer electrolyte material of claim 1, wherein the polymer has the formula (II): 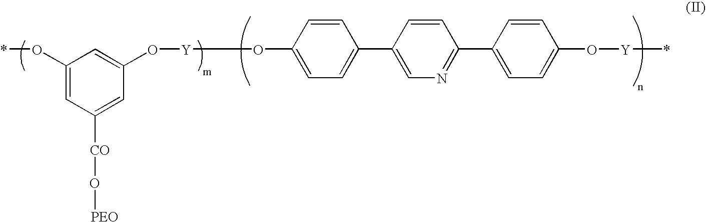
wherein Y is the same or different and is at least one of bis-(4-fluorophenyl)sulfone, 4,4′-difluorobenzophenone, decafluorobiphenyl, and bis(4-fluorophenyl)phenylphosphine oxide;
X is an aromatic unit having one, two or three benzene or heteroaromatic rings bearing one to four phosphonic acid moieties;
n is a positive integer between 0.95-0.7;
m is a positive integer between 0.05-0.3; and
PEO comprises a polyethylene oxide moiety having a molecular weight ranging from 750 to 5000.

4. The polymer electrolyte material of claim 1, wherein the polymer has the formula (III): 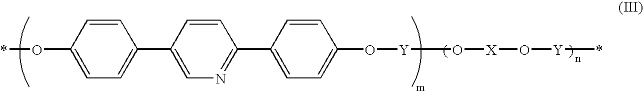
wherein Y is the same or different and is at least one of bis-(4-fluorophenyl)sulfone, 4,4′-difluorobenzophenone, decafluorobiphenyl, and bis(4-fluorophenyl)phenylphosphine oxide;
X is an aromatic unit having one, two or three benzene or heteroaromatic rings bearing one to four phosphonic acid moieties;
m is a positive integer between 0.95-0.5; and
n is a positive integer between 0.05-0.5.

5. The polymer electrolyte material of claim 1, comprising one or more polymer in the form of block, random, periodic and/or alternating polymers.

6. The polymer electrolyte material of claim 1, comprising two or more distinct polymers.

7. The polymer electrolyte material of claim 1, formed by a nucleophilic aromatic substitution reaction.

8. The polymer electrolyte material of claim 7, wherein the polymer is synthesized by reaction of materials comprising one or more aromatic difluorides.

9. The polymer electrolyte material of claim 1 further comprising one or more organic base heterocycles.

10. The polymer electrolyte material of claim 9 wherein the one or more organic base heterocycles are imidazole derivatives.

11. The polymer electrolyte material of claim 10 wherein the imidazole derivatives are selected from imidazol, pyrazole, methyl-imidazole or other imidazole derivatives.

12. A membrane comprising the polymer electrolyte material of claim 1.

13. A membrane electrode assembly (MEA) comprising the polymer electrolyte material of claim 1.

14. The membrane electrode assembly (MEA) of claim 13 comprising an anode-membrane-cathode sandwich.

15. The membrane electrode assembly (MEA) of claim 14, wherein each electrode in the sandwich structure comprises separate layers comprising (i) a substrate layer, (ii) a gas diffusion layer, and (iii) a reaction layer.
